(19) United States
(12) Patent Application Publication
(10) Pub. No.: US 2022/0368183 A1
(43) Pub. Date: Nov. 17, 2022

(54) ROTOR FOR A SYNCHRONOUS MACHINE

(71) Applicant: XYLEM EUROPE GMBH, SCHAFFHAUSEN (CH)

(72) Inventors: Fabio REFFO, Altavilla Vic.na (IT); Riccardo BICEGO, Castelgomberto (IT)

(21) Appl. No.: 17/764,268

(22) PCT Filed: Nov. 17, 2020
(86) PCT No.: PCT/EP2020/082407

§ 371 Date: Mar. 28, 2022

(30) Foreign Application Priority Data
Nov. 18, 2019 (EP) 19209788.9

(51) Int. Cl. H02K 1/279; H02K 1/24

(52) U.S. Cl. CPC H02K 1/279; H02K 1/246

(57) ABSTRACT

A rotor for a synchronous machine is described. The rotor includes a central axis; a bore being centrally positioned and extending axially relative to the central axis. Poles are arranged around the bore and poles extend axially in a direction parallel to the central axis. An air gap surface is configured to face an air gap and slots mutually angularly spaced relative to the central axis wherein each slot extends axially in a direction parallel to the central axis and wherein each slot is adjacent the air gap surface.

### TECHNICAL FIELD

This disclosure relates to the field of synchronous machines, in particular to the field of cogging torque reduction in synchronous machines, and more in particular to the field of cogging torque reduction in synchronous reluctance machines.

### BACKGROUND

Synchronous machines are generally known. In a synchronous reluctance machine, generally, there is a stator with multiphase windings forming a plurality of poles which are similar to those of induction motors. The synchronous reluctance machine also includes a rotor that does not use windings but does have the same number of poles as the stator. By providing a rotating field in the stator windings, a magnetomotive force acts upon the rotor resulting in the rotor being driven at a synchronous speed proportional to the rotating field in the stator. In an IPM synchronous machine, typically, there is a stator with multiphase windings and a rotor that has interior permanent magnets mounted thereon.

In a conventional synchronous machine the rotor is intended to rotate within an embracing stator. The rotor poles extend radially outwardly and the stator poles radially inwardly. It is also known to arrange the machine such that an outer rotor has radially inwardly extending poles and the inner stator has radially outwardly extending poles.

The rotor may be transversely laminated and comprises a stack of laminations of a suitable ferromagnetic material. The laminations, each, define the profile of the rotor bore and a series of angularly arranged rotor poles. The axial bore receives a shaft for rotational motion. The laminations in this form of reluctance machine lie in planes which are perpendicular to the axis of rotation of the rotor.

Independent of the machine type, a cogging torque may be generated by the discontinuity of the stator lamination at the airgap. The discontinuity is caused by the teeth of the stator. During operation, cogging torque may reduce the efficiency of the motor and cause vibrations that can adversely affect both the motor and driven loads. Cogging torque also can degrade the quality of the product associated with the driven load. Lower cogging torque leads to decrease in transient losses in the reluctance machines as well as smoother reaction to electrical torque inputs.

There are a number of approaches to reduce or avoid cogging torque. Such approaches include rotor skewing which sectioning the core and introducing a relative angular rotation to each section. Another approach involves varying the shape of the magnets or the magnetization paths.

While various approaches have been taken to reduce or avoid such cogging, the aforementioned approaches have not provided a suitable solution. Accordingly, there is a need for a new approach to the problem of attenuating cogging torque.

The present disclosure is directed, at least in part, to improving or overcoming one or more aspects of the prior art system.

### SUMMARY

The present disclosure describes a rotor for a synchronous machine, the rotor comprising a central axis; a bore being centrally positioned and extending axially relative to the central axis; a plurality of poles arranged around the bore, the poles extend axially in a direction parallel to the central axis; an air gap surface configured to face an air gap; and a plurality of slots mutually angularly spaced relative to the central axis wherein each slot extends axially in a direction parallel to the central axis and wherein each slot is adjacent the air gap surface.

### BRIEF DESCRIPTION OF THE DRAWINGS

The foregoing and other features and advantages of the present disclosure will be more fully understood from the following description of various embodiments, when read together with the accompanying drawings, in which:

FIG. 1 is an isometric view of a rotor in the first embodiment, according to the present disclosure;

FIG. 2 is an isometric view of a rotor in the second embodiment, according to the present disclosure;

FIG. 3 is a cross-sectional view of a rotor in the first embodiment, according to the present disclosure;

FIG. 4 is a cross-sectional view of a rotor in the second embodiment, according to the present disclosure;

FIG. 5 is a cross-sectional view of a rotor, in the first embodiment, having slots in a triangular shape;

FIG. 6 is a cross-sectional view of a rotor, in the first embodiment, having slots in a disco-rectangular shape;

FIG. 7 is a cross-sectional view of a rotor, in the first embodiment, having slots in a shape of slits;

FIG. 8 is a cross-sectional view of an internally mounted permanent magnet type rotor in the first embodiment, according to the present disclosure;

FIG. 9 is a cross-sectional view of a permanent magnet assisted type rotor in the first embodiment, according to the present disclosure;

FIG. 10 is a variation of a cross-sectional view of a permanent magnet assisted type rotor in the first embodiment, according to the present disclosure;

FIG. 11 is a schematic drawing of a synchronous machine with an internally positioned rotor; and

FIG. 12 is a schematic drawing of a synchronous machine with an externally positioned rotor.

### DETAILED DESCRIPTION OF THE DRAWINGS

This disclosure generally relates to a rotor for a synchronous machine having a low torque ripple effect.

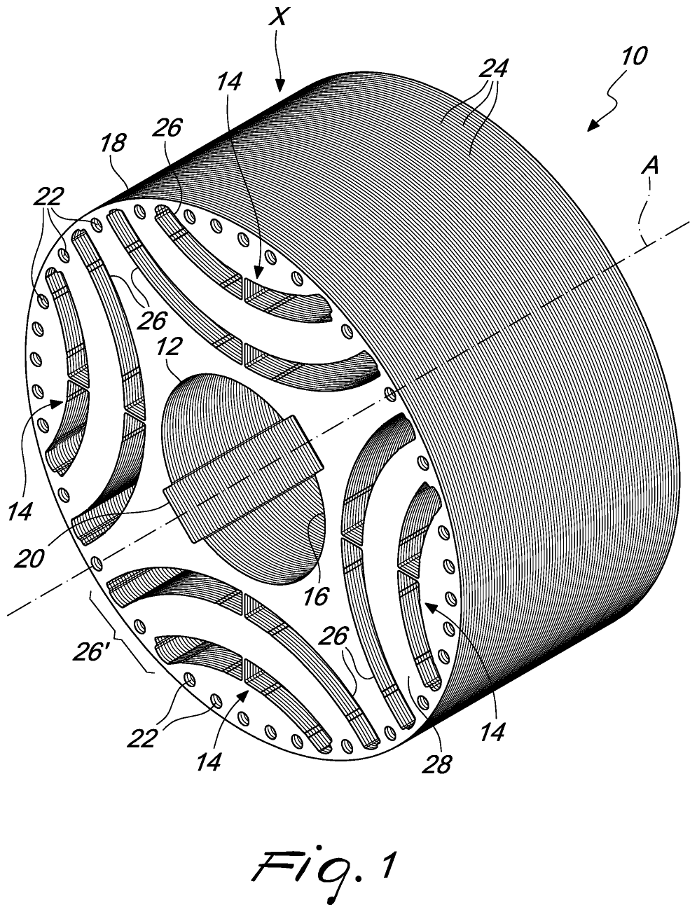

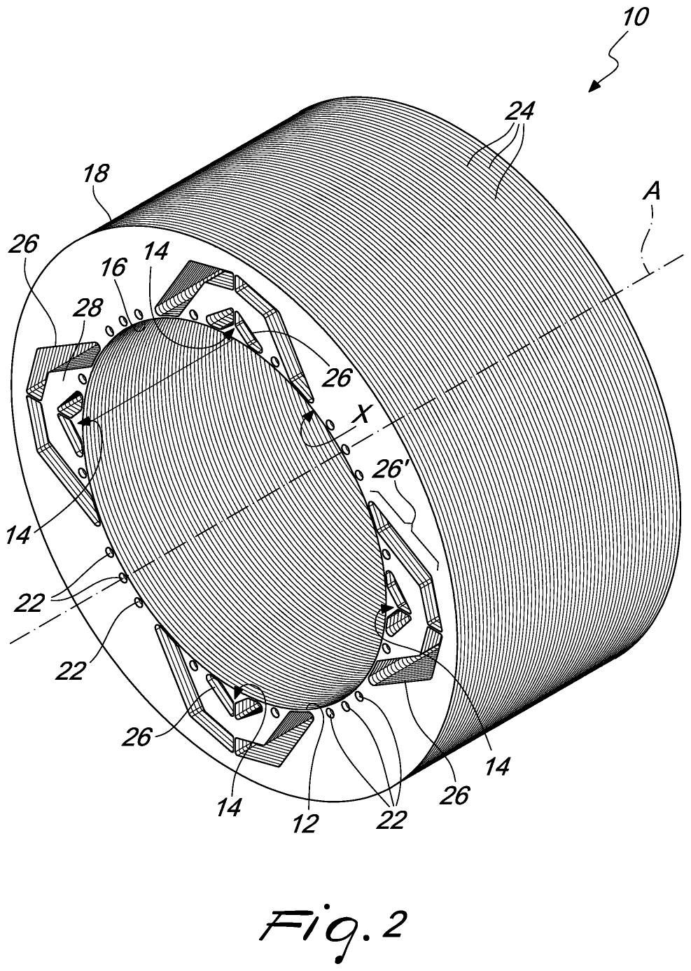

FIGS. 1 and 2 illustrate first and second embodiments of a rotor 10 for a synchronous machine (not shown). Each rotor 10 has a central axis A. The rotor 10 is configured to rotate about the central axis A. The rotor 10 has a bore 12. The bore 12 is centrally positioned in the rotor 10. The bore 12 extends axially relative to the central axis 12. A plurality of poles 14 are arranged around the bore 12. The poles 14 extend axially in a direction parallel to the central axis A. The rotors 10 in FIGS. 1 and 2 are shown with four poles 14. Other number of poles 14 may be provided as required. The rotor 10 has an internal surface 16 and an external surface 18. The internal surface 16 defines the bore 12.

The rotor 10 has an air gap surface X. The air gap surface X is the portion of the rotor 10 that borders an air gap in a synchronous machine. The air gap surface X faces onto the air gap. The air gap surface X is configured to face the air gap in a synchronous machine. The air gap surface X may be the internal surface 16 or the external surface 18 of the rotor 10. With reference to FIG. 1, in a rotor 10 that is configured as an inner rotor, the air gap surface X is the external surface 18. With reference to FIG. 2, in a rotor that is configured as an outer rotor, the air gap surface X is the internal surface 16.

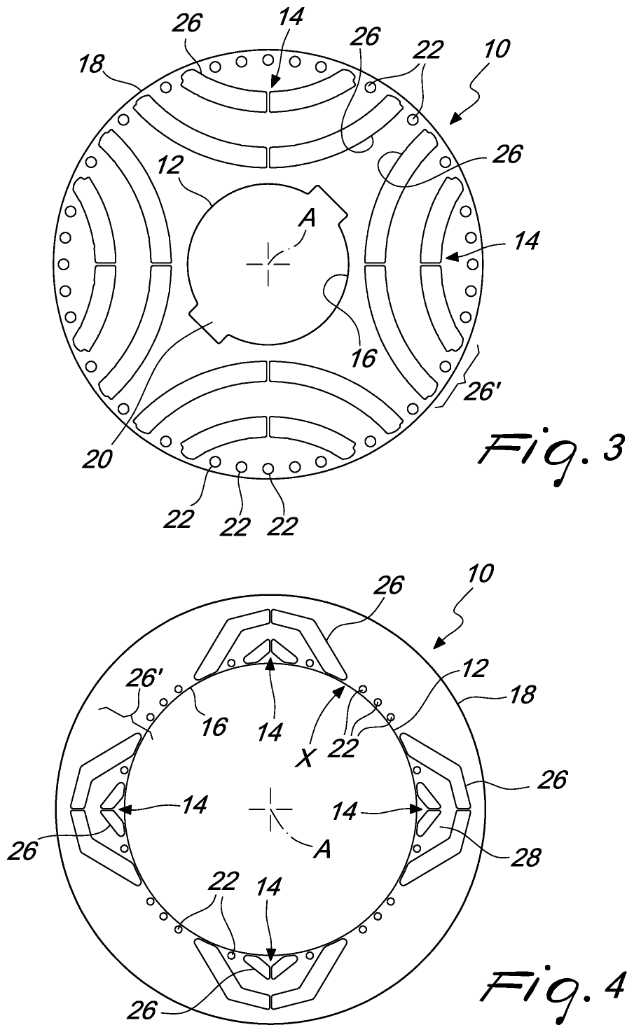

With respect to FIGS. 1 and 3, in the first embodiment, the bore 12 is configured to receive a transmission shaft (not shown). The bore 12 is configured in use for the connection of the rotor 10 with the shaft, to be actuated in a rotational motion. In this embodiment, notches 20 for abutment are provided for coupling to the transmission shaft. The notches 20 couple with keys or similar locking elements arranged on the transmission shaft. With respect to FIGS. 2 and 4, in the second embodiment, the bore 12 is configured to accommodate a stator (not shown). The bore 12 is configured to be actuated in a rotational motion around the stator. The bore 12 is sized to accommodate the stator.

With reference to FIGS. 2 to 4, the rotor 10 comprises a plurality of slots 22. The slots 22 function as a series of discrete magnetic field barriers. The plurality of slots 22 are mutually angularly spaced relative to the central axis A. The plurality of slots 22 are mutually spaced about the central axis A. The slots 22 are circumferentially positioned about the central axis A. In a cross section through the rotor 10, the slots 22 are separated and spaced apart along a circumferential direction. In an embodiment, the plurality of slots 22 are uniformly mutually spaced about the central axis A.

Each slot 22 extends axially in a direction parallel to the central axis A. The slots 22 are configured as through passages. Each slot 22 is positioned adjacent the air gap surface X. The plurality of slots 22 is circumferentially adjacent to the air gap surface X. The plurality of slots 22 border on the air gap surface X. The slots 22 are positioned along the periphery of the rotor 12. Slots 22 are not contiguous with the air gap surface. The plurality of slots 22 is arranged so as to be concentrically aligned relative to the air gap surface X.

Generally, the number of slots 22 (including the flux barriers) may be selected using the following relationship: (1.25÷1.35)*Q, where Q is the stator slot number.

The slots 22 encircle the plurality of poles 14. The plurality of slots 22 form a discontinuous magnetic field barrier around the plurality of poles 22. In an embodiment, the slots 22 are positioned between the air gap surface X and the plurality of poles 14.

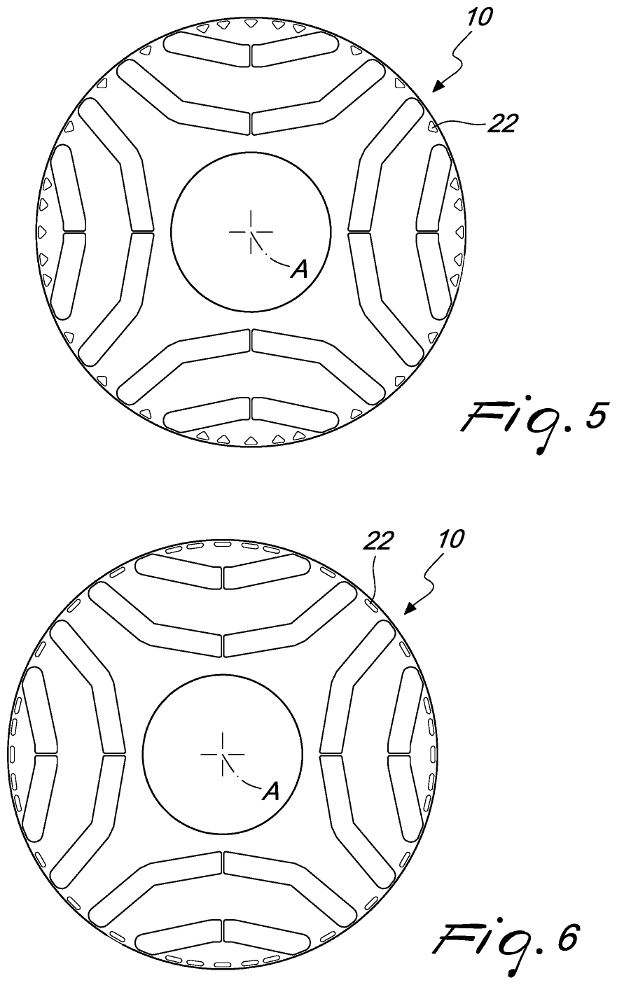

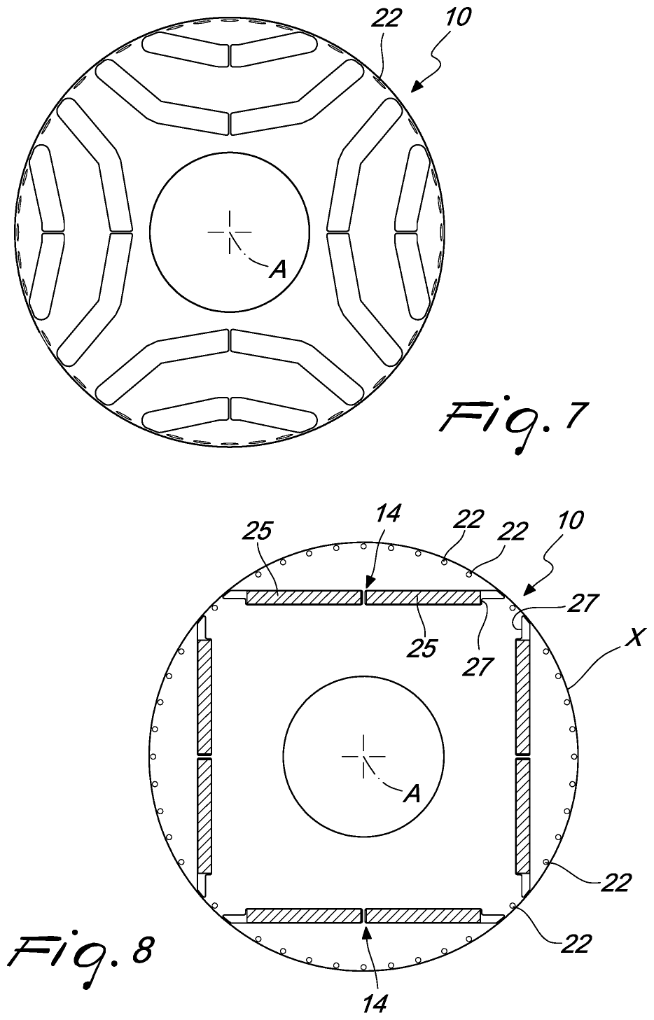

The slots 22 are calibrated in shape and size according to the size of the synchronous machine, stator slot number and rotor geometry. The shape of the slots 22 is selected from the group consisting of: circular, elliptical, disco-rectangular and triangular. FIGS. 3 and 4 illustrate the slots 22 with a circular shape. FIG. 5 illustrates the slots 22 with a triangular shape. In an embodiment, the apex of each triangle is orientated towards the central axis A. The orientation of the triangle may be varied as required. FIG. 6 illustrate the slots 22 with a disco-rectangular shape. FIG. 7 illustrate the slots 22 with an elliptical shape. In particular, elliptical slits.

With respect to FIG. 1, in the first embodiment, the rotor 10 is configured as an inner rotor. In this rotor 10, each slot 22 is radially spaced from the internal surface 16 and radially adjacent to the external surface 18. The plurality of slots 22 is circumferentially adjacent to the external surface 18. The plurality of slots 22 border on the external surface 18. The slots 22 are not contiguous with the external surface 18. The plurality of slots 22 is arranged so as to be concentrically aligned relative to the external surface 18.

The slots 22 encircle the plurality of the radially outwardly extending poles 14. The plurality of slots 22 form a discontinuous magnetic field barrier around the plurality of the radially outwardly extending poles 14. In an embodiment, the slots 22 are positioned between the external surface 18 and the plurality of the radially outwardly extending poles 14.

With respect to FIG. 2, in the second embodiment, the rotor 10 is configured as an outer rotor. In this rotor 10, each slot 22 is radially spaced from the external surface 18 and radially adjacent to the internal surface 16. The plurality of slots 22 is circumferentially adjacent to the internal surface 16. The plurality of slots 22 border on the internal surface 16. The slots 22 are not contiguous with the internal surface 16. The plurality of slots 22 is arranged so as to be concentrically aligned relative to the internal surface 16.

The slots 22 encircle the plurality of the radially inwardly extending poles 14. The plurality of slots 22 form a discontinuous magnetic field barrier around the plurality of the radially inwardly extending poles 14. In an embodiment, the slots are positioned between the internal surface 16 and the plurality of the radially inwardly extending poles 14.

In an embodiment, the rotor 10 is transversely laminated. The rotor 10 comprises a plurality of transverse laminates 24 stacked along an axial direction of the rotor 10. The rotor 10 is formed through the aligned stacking in succession of a plurality of the transverse laminates 24. The transverse laminates 24 are shaped like discs and are constrained to one another to constitute a cylindrical structure that constitutes the rotor N.

Each laminate 24 is made of ferromagnetic material. Each laminate 24 comprises flux barriers 26. The flux barriers 26 are formed as voids in the rotor 10. The flux barriers 26 may be curvilinear, linear or chevron shaped. The flux barriers 26 are arranged in groups 26′ where each group constitutes a pole 14. In the illustrated embodiment, in each group 26′ a plurality of flux barriers 26 are formed in each quarter circumferential angular region in the rotor 10. The flux barriers 26 is a plurality of voids.

Flux guides 28 are positioned adjacent the flux barriers 26. Flux guides 28 are interposed between the flux barriers 26. Flux guides 28 are positioned between flux barriers 26 in each group 26′.

The flux barriers 26 are arranged to define the poles 14. The poles 14 are mutually angularly spaced about the central axis A. The groups of flux barriers 26′ are arranged equidistant from one another in the angular direction along the rotor 10. The plurality of slots 22 are positioned around the plurality of poles 14. The plurality of slots 22 are positioned around the groups of flux barriers 26′. The slots 22 are positioned around the flux barriers 26 and the flux guides 28 that define the plurality of poles 14.

The groups flux barriers 26′ are positioned adjacent the air gap surface X with the plurality of slots 22 positioned between the groups flux barriers 26′ and the air gap surface X. The plurality of slots 22 are positioned between the flux barriers 26′ and the air gap surface X. The plurality of slots 22 are positioned between the air gap surface X and the flux barriers 26 and the flux guides 28.

The dimension slots 22 may be varied in respect to the type and the dimension of the synchronous machine. In an embodiment, the dimension of the slot 22 may be approximately one half of the flux barrier height 26. In a rotor 10 with a plurality of flux barriers 26, the flux barrier 26 closer to the air gap surface X is used reference.

If the slot 22 is circular the dimension is the diameter slot 22. If the slot 22 is not circular, the dimension is the width of the slot 22 that is approximately equal to the height of the flux barrier 26. In a rotor 10 with a plurality of flux barriers 26, the flux barrier 26 closer to the air gap surface X is used reference. In any case the minimum height or width cannot be smaller than the thickness of each laminate 24.

In an embodiment, the rotor 10 may of the internally mounted permanent magnet type where torque is produced by the presence of the magnets. The magnets further provide rotor magnetization. In an internally mounted permanent magnet type rotor 10 the flux barriers 26 may be the magnetic pockets where the permanent magnets are inserted.

FIG. 8 illustrates an internally mounted permanent magnet type rotor 10 configured as an inner rotor. The rotor 10 of the internally mounted permanent magnet type may configured as an outer rotor in accordance with the present disclosure. The rotor 10 comprises a plurality of magnet pockets 27. A plurality of magnets 25 are inserted in the respective magnetic pockets 27. The arrangement of the magnet pockets 27 may be configured as required.

A single magnet 25 may define a pole 14. In an embodiment, a plurality of magnets 25 are grouped to define respective plurality of poles 14.

The positioning of the magnetic pockets 27 demarks the arrangement of the magnets 25. The slots 22 are positioned around the plurality of magnetic pockets 27. The plurality of magnetic pockets 27 are positioned adjacent the air gap surface X with the plurality of slots 22 positioned between the magnetic pockets 27 and the air gap surface X. The slots 22 are positioned around the plurality of magnets 25. The plurality of magnets 25 are positioned adjacent the air gap surface X with the plurality of slots 22 positioned between the magnets 25 and the air gap surface X.

In an embodiment, the rotor 10 may be of the permanent magnet assisted type. FIG. 9 illustrates a permanent magnet assisted type rotor 10 configured as an inner rotor. The rotor 10 of the permanent magnet assisted type may configured as an outer rotor in accordance with the present disclosure. A plurality of magnets 25 are inserted in the respective flux barriers 26. In an embodiment, each flux barrier 26 is provided with a magnet 25. In an alternative embodiment, magnets 25 are inserted into a portion of the flux barriers 26 such that the remaining portion of the flux barriers 26 are not provided with magnets 25. The number and distribution of magnets 25 in each pole 14 is the same.

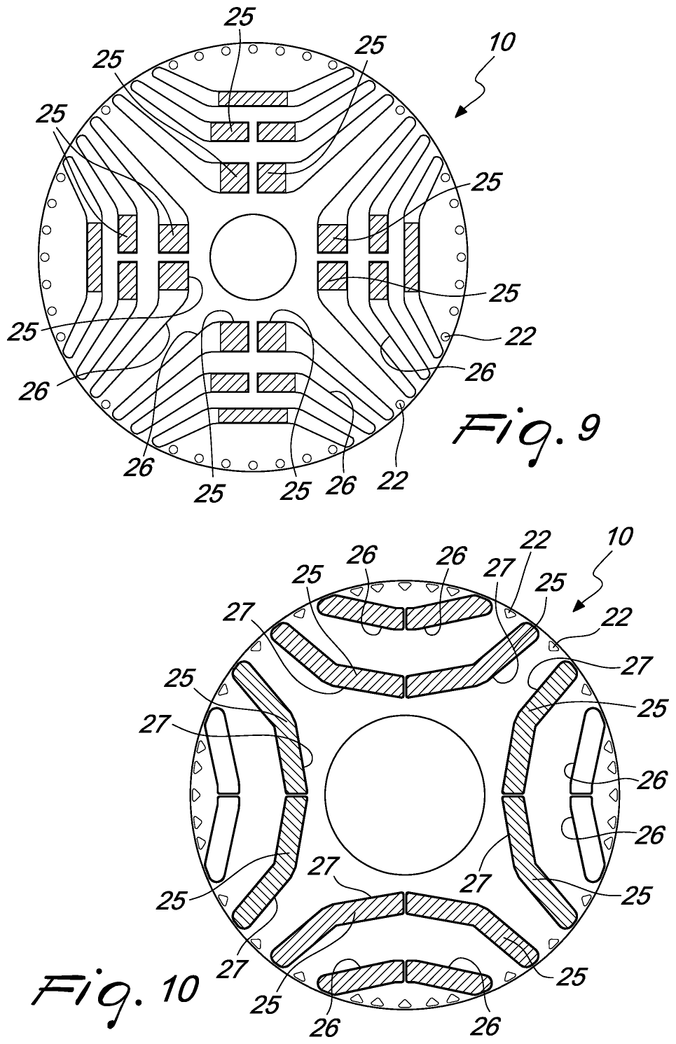

In an alternative embodiment, with reference to FIG. 10, the rotor 10 further comprises a plurality of magnet pockets 27 positioned with the flux barriers 26. The arrangement of the magnet pockets 27 may be configured as required. A plurality of magnets 25 are inserted in the magnetic pockets 27. The slots 22 are positioned around the flux barriers 26 and the magnetic pockets 27. The number and distribution of magnets 25 and magnetic pockets 27 in each pole 14 are the same.

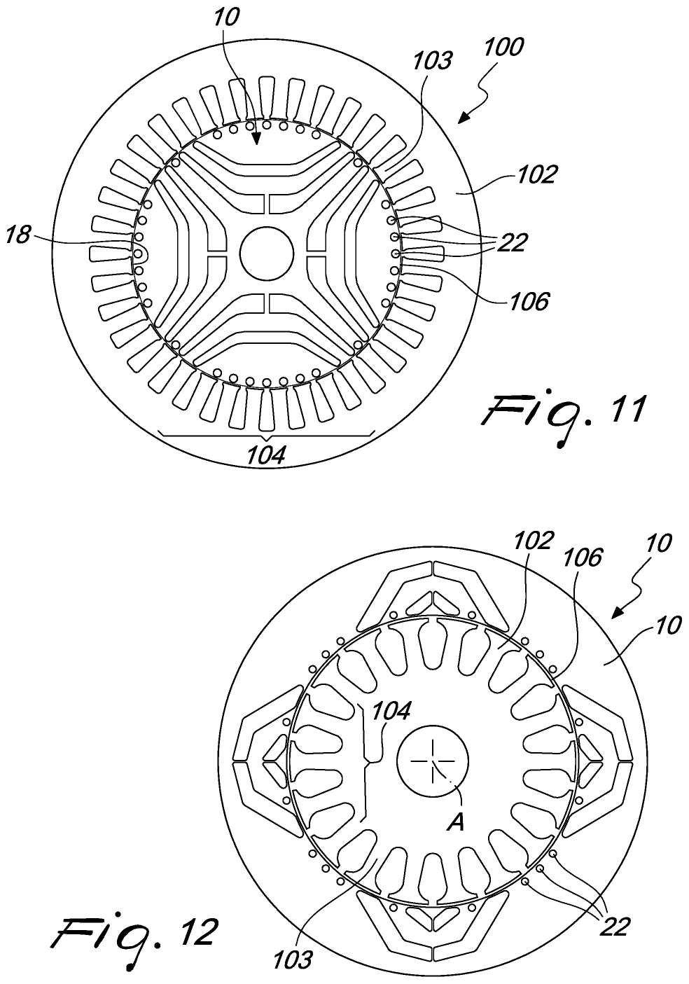

FIGS. 11 and 12 schematically illustrate first and second embodiments of a synchronous machine 100. Each of the synchronous machines 100 comprises a stator 102 for generating a rotating magnetic flux. Stator 102 comprises stator teeth 103. The stator teeth 103 are arranged in groups as stator poles 104. The synchronous machines 100 comprise a rotor 10 as herein described. The rotor 10 is spaced from the stator 102 by an air gap 106. The rotor 10 is configured for rotating about the central axis A relative to the stator 102 in synchronization with the rotating magnetic flux. Each slot 22 is positioned adjacent to the air gap 106. The air gap surface X faces the air gap 106 and the plurality of slots 22 are located adjacent to the air gap 106. In an embodiment, the synchronous machine 100 is a reluctance machine.

With reference to FIG. 11, the synchronous machine 100 has an inner rotor 10 and an outer stator 102. The external surface 18, of the rotor 10, faces the air gap 106. The air gap 106 encircles the plurality of slots 22. The plurality of slots 22 are positioned close to the air gap 106. The stator 102, at the inner peripheral portion that faces the rotor 10, has a plurality of stator windings. In use, the stator windings are fed in a controlled manner in order to generate a magnetic field that is variable in intensity and direction to determine the rotation of the rotor 10 about the central axis A.

With reference to FIG. 12, the synchronous machine 100 has an outer rotor 10 and an inner stator 102. The internal surface 16, of the rotor 10, faces the air gap 106. The plurality of slots 22 encircles the air gap 106. The plurality of slots 22 are positioned close to the air gap 106. The stator 102, at the outer peripheral portion that faces the rotor 10, has a plurality of stator windings. In use, the stator windings are fed in a controlled manner in order to generate a magnetic field that is variable in intensity and direction to determine the rotation of the rotor 10 about the central axis A.

The synchronous machine may be configured as permanent magnet assisted reluctance machine (not shown) comprising a permanent magnet assisted type rotor 10. The synchronous machine may be configured as an internally mounted permanent magnet machine (not shown) comprising an internally mounted permanent magnet type rotor N.

The skilled person would appreciate that foregoing embodiments may be modified or combined to obtain the rotor 10 of the present disclosure.

### INDUSTRIAL APPLICABILITY

This disclosure describes a rotor 10 for a reluctance machine. The rotor 10 is provided with a plurality of slots that enable the reduction or balancing of the magnetic flux fluctuation during rotation so as to reduce the cogging torque. The presence of the slots negates the alignment effect (reluctance effect) of the stator teeth and the rotor lamination. The slots are obtained directly on the rotor during lamination punching and stacking process.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

One skilled in the art will realize the disclosure may be embodied in other specific forms without departing from the disclosure or essential characteristics thereof. The foregoing embodiments are therefore to be considered in all respects illustrative rather than limiting of the disclosure described herein. Scope of the disclosure is thus indicated by the appended claims, rather than the foregoing description, and all changes that come within the meaning and range of equivalence of the claims are therefore intended to be embraced therein.

1. A rotor for a synchronous machine, the rotor comprising:
a central axis;
a bore being centrally positioned and extending axially relative to the central axis;
a plurality of poles arranged around the bore, the poles extend axially in a direction parallel to the central axis;
an air gap surface configured to face an air gap; and
a plurality of slots mutually angularly spaced relative to the central axis wherein each slot extends axially in a direction parallel to the central axis, each slot being adjacent the air gap surface and wherein the plurality of slots have the same shape.

2. The rotor of claim 1, further comprising an internal surface and an external surface, the internal surface defining the bore wherein the bore is configured to receive a transmission shaft wherein the air gap surface is the external surface and wherein each slot is radially spaced from the internal surface and radially adjacent to the external surface.

3. The rotor of claim 2, wherein the slots are arranged to be concentrically aligned relative to the external surface.

4. The rotor of claim 1, further comprising an internal surface and an external surface, the internal surface defining the bore wherein the bore is configured to accommodate a stator, wherein the air gap surface is the internal surface and wherein the each slot is radially spaced from the external surface and radially adjacent to the internal surface.

5. The rotor of claim 4, wherein the slots are arranged so as to be concentrically aligned relative to the internal surface.

6. The rotor of claim 1, further comprising a plurality of transverse laminates stacked along an axial direction of the rotor.

7. The rotor of claim 6, further comprising a plurality of magnet pockets wherein a plurality of magnets are inserted in the magnetic pockets wherein the slots are positioned around the plurality of magnetic pockets.

8. The rotor of claim 6, wherein each laminate comprises flux barriers, the flux barriers being arranged to define the poles wherein the poles are mutually angularly spaced about the rotational axis and wherein the slots are positioned around the plurality of poles.

9. The rotor of claim 8, further comprising a plurality of magnets wherein the plurality of magnets are inserted in the flux barriers.

10. The rotor of claim 7, wherein the plurality of magnet pockets are positioned with the flux barriers and wherein a plurality of magnets are inserted in the magnetic pockets.

11. The rotor of claim 1, wherein the shape of the slots is selected from the group consisting of circular, elliptical, disco-rectangular, and triangular.

12. A synchronous machine comprising:
a stator for generating a rotating magnetic flux, wherein the stator comprises stator poles; and
a rotor according to claim 1 wherein the rotor is spaced from the stator by an air gap, wherein the rotor is configured for rotating about the central axis relative to the stator in synchronization with the rotating magnetic flux and wherein the air gap surface faces the air gap and the plurality of slots located adjacent to the air gap.

13. The synchronous machine of claim 12, wherein the synchronous machine is a reluctance machine.

14. The synchronous machine of claim 12, wherein the synchronous machine is a permanent magnet assisted reluctance machine.

15. The synchronous machine of claim 12, wherein the synchronous machine is an internally mounted permanent magnet machine.

16. A rotor for a synchronous machine, the rotor comprising:
a central axis;
a bore being centrally positioned and extending axially relative to the central axis;
a plurality of poles arranged around the bore, the poles extend axially in a direction parallel to the central axis;
an air gap surface configured to face an air gap; and
a plurality of slots mutually angularly spaced relative to the central axis wherein each slot extends axially in a direction parallel to the central axis and wherein each slot is adjacent the air gap surface.
